(19) United States
(12) Patent Application Publication
(10) Pub. No.: US 2001/0003539 A1
(43) Pub. Date: Jun. 14, 2001

(54) Telephone keypad having a dual-switch button

(76) Inventors: Jin Ho Hahm, Taejon (KR); Jung Soo Park, Taejon (KR)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/733,803

(22) Filed: Dec. 7, 2000

(30) Foreign Application Priority Data
Dec. 7, 1999 (KR) 1999-55545

(51) Int. Cl. H04M 1/00; H04M 3/00

(52) U.S. Cl. 379/368; 379/369

(57) ABSTRACT

There is disclosed a telephone keypad apparatus having a dual-switch button in which each of switch contacts can be individually operated depending on the locations at which the buttons are pushed, by mounting two switches for every button in the telephone keypad. In accordance with the present invention, in a telephone keypad in which twelve push buttons are arranged in a grid shape, each of the buttons has two switches for connecting/disconnecting an electrical flow and the buttons are pushed freely right and left. If the left of the button key cap is pushed the left switch is connected, if the right of the button key cap is pushed the right switch is connected and if the middle of the button key cap is pushed both the switches are connected.

### TECHNICAL FIELD

The invention relates generally to a keypad apparatus in a telephone. More particularly, the present invention relates to a telephone keypad apparatus having a dual-switch button in which each of switch contacts can be individually operated depending on the locations at which the buttons are pushed, by mounting two switches for every button in the telephone keypad.

### BACKGROUND OF THE INVENTION

Years ago, the keypad of the telephone keypad was used merely as a means for inputting a telephone number. Recently, however, a telephone into which a telephone directory is built has showed up. A function of communicating letters is also added to the telephone. Further, as a letter pager has been widely used, the keypad of the telephone has been extendedly used as a letter input means. The keypad of the telephone has, however, a limited number of buttons, i.e., 12, in which 3 or 4 alphabets are allocated every button unlike the keyboard of the computer Thus as the letters displayed on a key cap and the buttons do not correspond to each other one to one, there is a problem that input of letters are not inconvenient. Therefore, in order to solve this problem, various approaches by which the keypad is employed as a letter input means have been considered.

As an example, there is a method by which a button on which letters to be inputted are arranged is pushed to input a desired alphabet in the telephone keypad in which alphabets from A to Z are arranged and the buttons having the numbers from 1 to 4 are then pushed in order to specify what order of the letters is. For example, in order to input “C,” the second button of the buttons in which “ABC” is arranged is pushed and the third button meaning the third is then pushed. Also in order to input “Z,” the ninth button of the buttons in which “WXYZ” is arranged is pushed and the fourth button is then pushed. This method, however, is inefficient since it must push the button twice in order to input any alphabets. Also there is a problem that this method is sensitive to generation of errors since any error occurred during the process of inputting text strings may affect a subsequent letter.

Seeing U.S. Pat. No. 5,032,206 entitled “METHOD AND APPARATUS FOR IDENTIFYING WORDS ENTERED ON DTMF PUSHBUTTONS” issued to Fox-EC, Inc, in which letters are displayed on a display window of a telephone and a corresponding letter when a user touches a letter on the display window is displayed. Though distinction of a capital letter and a small letter and input of respective alphabet of other letters are possible since all letters can be represented on the display, it has to display all the letters on the display having a small area. Therefore, there are problems that it is difficult to select small letters with fingers, the feedback that letters on the display are selected is weak and the input speed is slow.

Also there is a U.S. Pat. No. 5,577,118 entitled “TELEPHONE-TERMINAL COMBINATION WITH PLURAL KEYBOARDS” issued to Verifone, Inc., in which a keyboard for inputting letters as in the computer is additionally mounted on a telephone. Though this may be used in the case that input of lots of letters are required such as an Internet phone, a two-way text pager, etc., at least 40 number of buttons are necessary in order to allocate alphabet and numbers. Therefore there are problems the apparatus is bulky and clumsy and manipulation of the button is bad since the size of the button is small when the apparatus is miniaturized.

Further there is a U.S. Pat. No. 5,339,358 entitled “TELEPHONE KEYPAD MATRIX” issued to Danish International, Inc., in which alphabets are arranged in the spaces between the buttons and a corresponding alphabet is selected by pushing two neighboring buttons are consecutively pushed. For example, the alphabet “A” indicated at the outside of the button numbered “1” is inputted by pushing the button “1” twice and the alphabet “G” indicated between the buttons “1” and “5” is inputted by pushing the buttons “1” and “5” consecutively. This method, however, is inefficient since it does not use a standard alphabet arrangement in the keypad and the buttons must be pushed twice in order to input alphabets.

In addition, there is a method by which a letter is converted into a corresponding alphabet by a letter recognition function by directly writing the character on a display window having a pen input function with stylus pen. This method, however, has problems that it needs an additional device and a letter recognition rate is not yet high.

### SUMMARY OF THE INVENTION

The present invention is contrived to solve these problems and an object of the present invention to provide a telephone keypad apparatus with a dual-switch button in which each of switch contacts is individually operated depending on the location at which the buttons are pushed, by mounting two switches for every button of a telephone keypad.

In accordance with the present invention, in a telephone keypad in which twelve push buttons are arranged in a grid shape, each of the buttons has two switches for connecting/disconnecting an electrical flow and the buttons are pushed freely right and left. If the left of the button key cap is pushed the left switch is connected, if the right of the button key cap is pushed the right switch is connected and if the middle of the button key cap is pushed both the switches are connected.

Preferably, the keypad further comprises a shield wall having a given height between the push buttons arranged in rows and columns in order to discriminate the plurality of push buttons arranged in rows and columns.

More preferably, the right and left edges of the plurality of push buttons are formed higher by a given height than the middle portion of the plurality of push buttons.

It is preferable that the middle portion of the plurality of push buttons are formed lower by a given depth than the right and left edges of the plurality of push buttons. It is more preferable that the switch is formed using a membrane tactile method.

Also, two projections are preferably formed at the right and left sides overlying the plurality of push buttons, so that the left projection corresponds to the left switch and the right projection corresponds to the right switch, and when the left buttons of the plurality of the push buttons are pushed, the right and left projections push the upper side of the right and left switches while the right and left sides of the plurality of the push buttons are get folded.

Preferably, the keypad apparatus is constructed to input all the alphabet letter, numbers and special keys, by matching two alphabet letters for every two switches in each of the plurality of push buttons and matching one of the alphabet letters when the two switches are pushed at the same time, depending on a predetermined method.

More preferably, the switches match the letters by discriminating the case it is pushed for a longer time than a given time and the case it is pushed for a shorter time than a given time, respectively.

Also preferably, the buttons for matching the letters by discriminating the case it is pushed for a longer time than a given time and the case it is pushed for a shorter time than a given time, respectively has a box hoop or a circular hoop on their surfaces in order to discriminate other buttons.

According to another aspect of the present invention, a keypad apparatus in a telephone in which a plurality of push buttons are arranged in rows and columns in a grid shape is provided to includes a switch input means wherein two push switches are consisted of for every one of the plurality of push buttons, a switch detecting means for detecting the connecting state in each of switch contacts to determine whether any of the switches is connected or not, a controller means for converting the switch input state determined at the switch detecting means into a predetermined format data format, and a display means for displaying the contents of the input data by means of the controller means, wherein each of the push buttons are freely pushed right and left, two switches for connecting/disconnecting an electrical flow are installed at the right and left of each of the push buttons, wherein if the lefts of said push buttons are pushed left switches are connected, if the rights of said push buttons are pushed right switches are connected and if the middles of said push buttons are pushed both the right and left switches are connected.

Preferably, the keypad further comprises a buzzer for generating a given sound depending on a predetermined rule according to the contents of data transmitted from the switch detecting means.

More preferably, the keypad further comprises a lamp for lighting or un-lighting depending on a predetermined rule according to the contents of data transmitted from the switch detecting means.

It is preferable that the switch detecting means disregards detection of other switches except for its opposite switch existing at the same button if a switch firstly connected after all of the switches are open is detected, and also accepts only the case the contact of the switch connected firstly connected is open or the case the contact of the opposite switch at the same button, as a continuous input.

### BRIEF DESCRIPTION OF THE DRAWINGS

The aforementioned aspects and other features of the present invention will be explained in the following description wherein:

FIG. 1 shows a construction of a keypad with a dual switch button according to one preferred embodiment of the present invention;

FIG. 2 is a side view of the keypad shown in FIG. 1 for illustrating the states in which the keypad is not pushed and the switch is open;

FIG. 3 is an enlarged view illustrating a keycap edge of the keypad button in FIG. 1;

FIG. 4 is a diagram showing the states in which the right of the keypad button is pushed and the right switch is connected;

FIG. 5 is a diagram showing the states in which the right of the keypad button is pushed and the left switch is connected;

FIG. 6 is a diagram showing the states in which the right and left of the keypad buttons are pushed and the right and left switches are connected;

FIG. 7 shows an electrical structure of the keypad shown in FIG. 1; and

FIG. 8 is an exterior view of the telephone on which the keypad shown in FIG. 1 is mounted.

### DETAILED DESCRIPTION OF THE INVENTION

The present invention will be described in detail by way of a preferred embodiment with reference to accompanying drawings.

Every button constituting a keypad of the present invention is allocated two switches. Assuming that the two switches are closely positioned. The states in which the switch contacts are connected make possible confirming whether the left switch is pushed, the right switch is pushed or both the switches are pushed. Considering that the switches are pushed for a long time, it is possible to confirm more than eight states: the left switch is pushed for a long time, the right switch is pushed for a long time, both the switches are pushed for a long time, the right switch is pushed after the left switch is pushed for a long time and the left switch is pushed after the right switch is pushed for a long time, etc.

Of them, except for the states having the high possibility of error upon manipulation, if the five states such as the left switch is pushed, the right switch is pushed, both the switches are pushed, the left switch is pushed for a long time and the right switch is pushed for a long time are considered as effective inputs of the switches, the five inputs can be distinctly represented with only one button.

The present invention constitutes a telephone keypad with a push button having two switch contacts for a button. Thus, it distinctly receives input of letters by corresponding the letters on respective key caps the five manipulations separated by the position/the time at which/when the buttons are pushed.

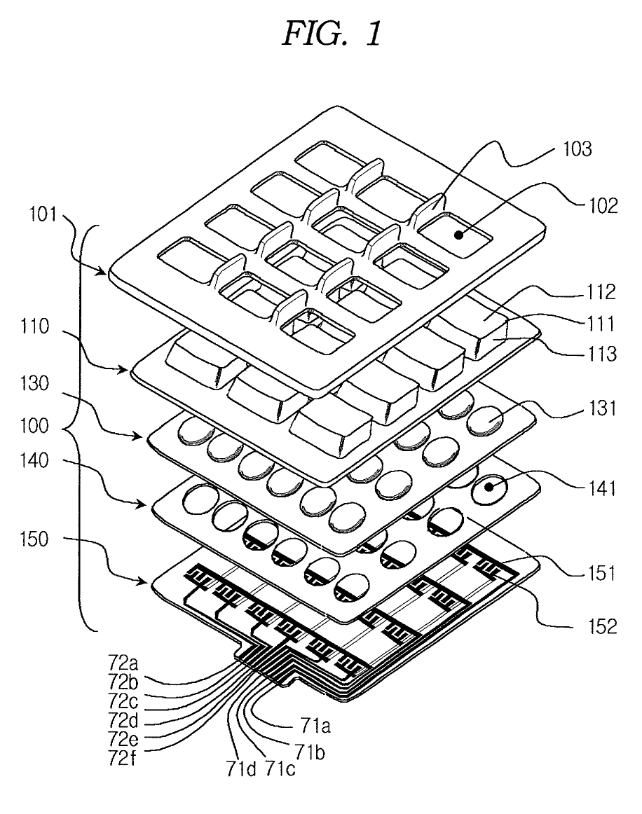

Referring now FIG. 1, a telephone keypad apparatus with a dual switch button according to one preferred embodiment of the present invention will be below explained in detail.

The keypad 100 mainly includes a plastic cover 101, a silicon rubber plate 110, a membrane sheet 130, a spacer 140 and a circuit board 150.

The plastic cover 101 has holes 102 through with the buttons 111 pass and shield walls 103 are installed between the holes 102. The silicon rubber plate 110 includes twelve buttons 111. On key caps 112 of the buttons are displayed numbers and letters and the sides 113 of the buttons are flexible so that they can transform depending on push. The membrane sheet 130 includes twenty-four membranes tactile 131. The spacer 140 is a non-conductive plate having twenty-four holes 141 and also provides the membrane tactile 131 with a space for connection with the electrodes 151, 152 of the circuit board when it are transformed. The circuit board 150 includes twenty-four pairs of the electrodes 151, 152, so that they can form a circuit depending on the user's push on the buttons.

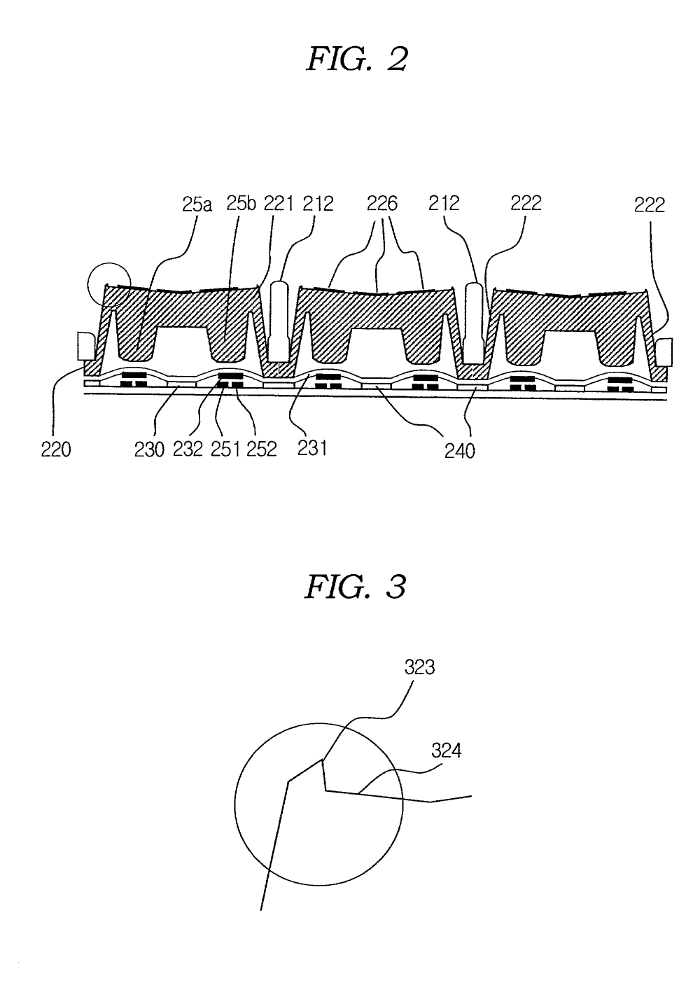

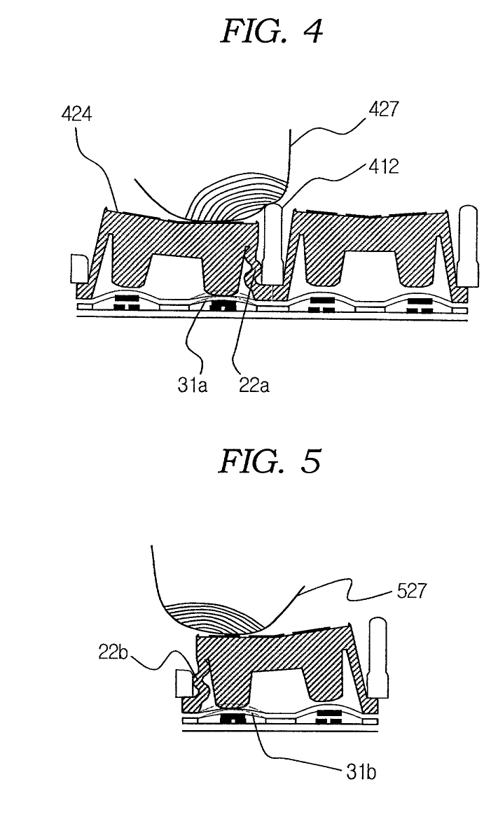

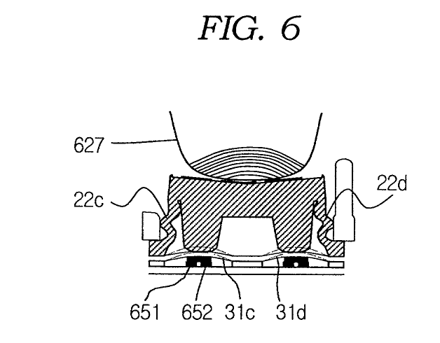

FIG. 2 is a side view of the keypad shown in FIG. 1, for illustrating the states in which the keypad is not pushed and the switch is open, FIG. 3 is an enlarged view illustrating a keycap edge of the keypad button in FIG. 1, FIG. 4 is a diagram showing the states in which the right of the keypad button is pushed and the right switch is connected, FIG. 5 is a diagram showing the states in which the right of the keypad button is pushed and the left switch is connected and FIG. 6 is a diagram showing the states in which the right and left of the keypad buttons are pushed and the right and left switches are connected.

Now the present invention will be explained in detail with reference to the above FIGS. 2 to 6.

A silicon rubber plate 220 that is compress-formed includes twelve buttons 221. The outer wall 222 of each of the buttons is resilient, so that if it is pushed it is compressed with wrinkles. The compressed shapes of the button wall are indicated by reference numerals 22a in FIG. 4, 22b in FIG. 5 and 22c, 22d of FIG. 6. The silicon rubber plate that is integrally formed prevents a foreign substance from intruding into the underlying circuit board. On a key cap 324 of the silicon button is printed numbers and letters 226. Two boundaries between the longitudinally arranged three buttons has a shield wall 103 higher 1-2 mm than the height of neighboring buttons. When the left or the right on a button at the boundary between neighboring two buttons is pushed, the shield wall prevents the neighboring two buttons from being pushed together, as shown in FIG. 4.

If one side of the button is pushed, the button is obliquely pushed, as shown in FIGS. 4 and 5. In order to facilitate this manipulation, the middle of the key cap 324 is constructed to slightly lower than the both ends thereof. Also both edges of the button has a raised portion 323 higher about 0.5-1 mm than the key cap 324, which thus provides a friction force so that finger are prevented from sliding when the button is pushed.

The bottom of the button has two projections 25a, 25b. When the user pushes the button, these projections contact the underlying membrane tactile 231 to thus provide pressure to it, which transforms the membrane tactile 231. The shapes of the membrane tactile that is transformed by the projections are indicated by reference numerals 31a in FIG. 4, 31b in FIG. 5, and 31c and 31d in FIG. 6.

The membrane sheet 230 is made of a metal of a stainless steel type having a good compression-extension rate. The membrane tactile 231 also has a circular shape or an eclipse shape such as contact lens with the membrane sheet 230 embossed. If the upper of the membrane tactile 231 is applied by pressure, it transforms to be lowered. If the pressure is removed, however, it returns to its original shape. The transform property of the membrane switch is not transformed until a certain degree of pressure is applied, but if the pressure exceeds a certain pressure it transforms to be lowered.

It is important that a clear feedback on a push manipulation is provided to the user since the user must manipulate the two switches using a single button. For the operation of the switches of a membrane mode, an actuation force over a certain degree by which the button is pushed and a contact force from which the pressure is initially reduced during the process in which the button is pushed, must be designed. In order to provide the user with the touch by which the user can feel that the button has been pushed, it is required that a snap rate which divides the difference between the actuation force and the contact force by the actuation force must be about 50%. In the present invention, the actuation force of each of the switches is designed to be about 100-200 gram. Therefore, in order for any one of the right switch or the left switch to be driven, it is sufficient to apply a force about of 100-200 gram to any one of the left and the right of the button. In order for both the switches to be pushed, however, it is required that a force of 200-400 gram be applied to the middle of the button. As such, as the actuation force for the operation of the button is different, whether one of the switches is pushed or both the switches are pushed can be sensitively controlled by controlling the button manipulation pressure based on the touch acquired through skill of the button manipulation procedure.

On the bottom of the membrane tactile 231 is attached a conductive pill 232. The conductive pill 232 is generally made of a small circular metal piece of a stainless steel type and is sometimes coated with gold in order to lower its resistance and improve its reliability.

Below of the membrane sheet 230 is located a spacer 240 having a circular hole depending on the position of the membrane tactile 231. The spacer 241 is made of a non-conductive material. The spacer acts to prevent the membrane sheet 230 of a metal or a plastic from directly contacting the circuit board and also provides a space within which the membrane tactile 231 can sufficiently transform when being transformed by pressure.

Below the spacer 240 is located a circuit board. The circuit board has electrodes 251, 252 corresponding each of the membrane switches. The two electrode 251, 252, being spaced apart, are contacting the conductive pill 232 attached to the membrane tactile 231 that is transformed by the push force of the button, thus forming a circuit.

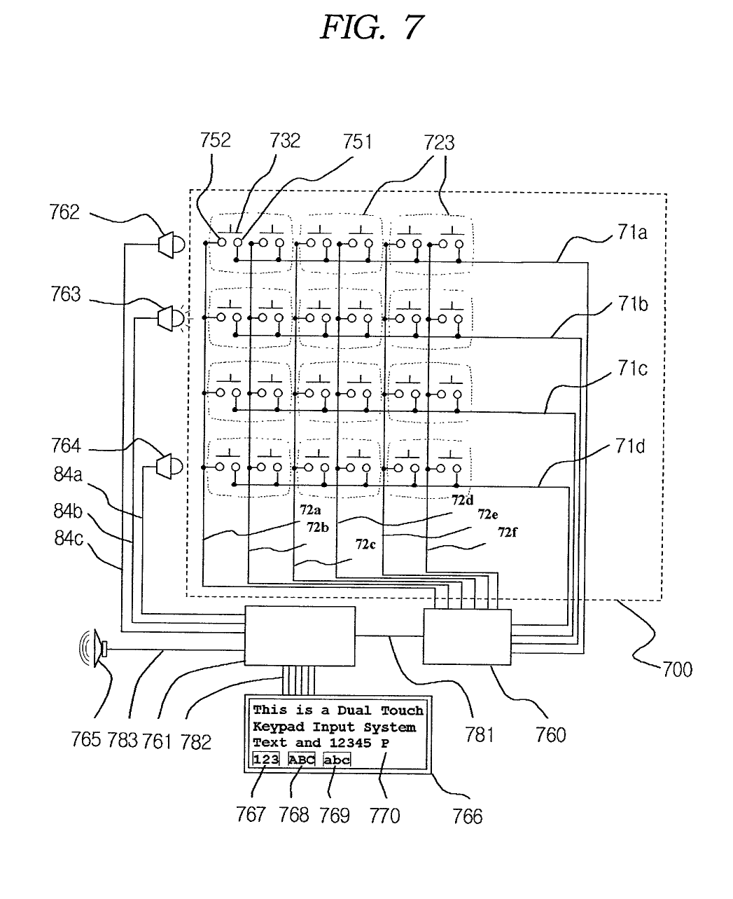

Referring now to FIG. 7, an electrical structure of the keypad in FIG. 1 will be explained in detail. The structure includes a keypad 700, a switching detector 760 for receiving signals from the keypad to determine whether the switch has connected or not, a controller 761 for receiving data on the switching from the switching detector 760, and a means for outputting the results from the controller 761 to a display 766, a buzzer 765 and lamps 762, 763 and 764, respectively.

Below each of the twelve buttons 723 is a pair of switch contacts. The right or the left or both them of these contacts is or are pushed depending on the position at which the user pushed the button. The switching detector 760 senses that switch is connected. If the left of the number “1” button in the first line from the top is pushed, current will flow into the circuits 72a and 71a in the switching detector 760. If the right of the number “2” button in the first line is pushed, current will flow into the circuits 72d and 71a in the switching detector 760. The switching detector 760 detects which circuit current flows through, thus confirming that which switch of which button is connected. The switching detector 760 can detect the state in which a neighboring button is erroneously pushed together.

For example, in the state in which the left switch in the number “2” button is connected with the right switch in the number “1” button being connected, current will flow into the circuits 72b and 71a and will later flow into the circuit 72c and 71a. The switching detector 760 recognizes only the state in which a neighboring switch in the same button is connected, as an effective connection, until the current flowing into the circuits originally formed is disconnected. Therefore, the switching detector 760 detects all the signals electrically but recognizes a secondary connection not occurring within the same button as an error. The switch connection state detected by the switching detector 760 experiences an effective value process and is then passed to the controller 761.

The switching detector 760 distinctly determines whether the switch is pushed for a short time and whether the switch is pushed for a long time. The fact that the switch is pushed for a long time, however, can be determined only after a certain period of time has elapsed from the time when the switch is pushed. Therefore, the switching detector 760 passes over the data preferentially determined to the controller 761 and after a certain time is elapsed, if it determines that the button is pushed for a lone tome, it modify it.

In accordance with this method, a transitional phenomenon may occur as follows. The first transitional phenomenon is occurred due to the difference between the times when the two switches in the same button are pushed. Both the switches in the same button could not be pushed at the same time. There will be a time difference of at least several milliseconds to several tens of millisecond. Therefore, the switching detector 760, taking this time difference, waits for about 50 seconds after one switch is pushed, and then determines whether the other switch is connected or not and then passes the result to the controller 761. In the case that both the switches in a button is connected, the time is within 50 milliseconds. In case that the other switch in the same button is connected after this time, however, modification on the data transmitted to the controller 761 is required. Therefore, the switching detector 760 transmits the data declaring that the data just transmitted has an error and thus transmits a modified data. The process in which the already transmitted data is modified will be explained later.

The controller displays on a display panel a letter corresponding to a button according to the situation transmitted from the switching detector 760. This case, therefore, needs a process by which the already displayed letter is deleted and a new letter is displayed.

The second transitional phenomenon to be considered is concerned with the case that the left or right button is pushed for a long tome, which is applied to the numbers “1,” “4,” “9” and “*” buttons. Let us explain about the case that the number “7” button is pushed for a long time. In the alphabet mode, if the left of this button is pushed for a short time a “Q” letter is inputted, and if the left of the button is pushed for a long time a “P” letter is identified. However, at the time point when the button begins to be pushed, it is difficult to determine which letter of the “Q” letter or the “P” does the user wants to input. Therefore, if the other switch is not pushed after about 50 milliseconds elapsed from the time point when one switch begins to be pushed, the switching detector 760 informs that the left switch of the number “7” button has been pushed to the controller 761, which thus displays the “Q” letter on the display panel based on this signal. If the user continuously pushes the left of the number “7” button since he/she wants to input the “P” letter, however, the switching detector 760 detects this fact to inform that the transmitted data has an error and then to inform a new data. Therefore, in case that the “P” letter is to be inputted, the “Q” letter is always first displayed, and some time later the process by which the “Q” letter is modified to the “P” letter is displayed on the display panel. Similarly in the case of Z, the “Y” letter is always first displayed, and the process by which the “Y” letter is changed to the “Z” letter is displayed on the display panel.

The data format on the switching state over which the switching detector 760 passes to the controller 761 is shown in Table 1 as follows:

TABLE 1

| | | | | | | | |
|---|---|---|---|---|---|---|---|
| b7 | b6 | b5 | b4 | b3 | b2 | b1 | b0 |

As can be seen from Table 1, a row in the keypad has six switches arranged. The number of the right most switch is assigned 0, the number of the left most switch is assigned 5 and the numbers of the switches between them are consecutively assigned. Bits b2-b0 are ones that the numbers of the switches are represented as a binary number. All of the switches are arranged in four columns. The first line is represented as a 0-th row, the last line is represented as a third row and the rows between them are consecutively displayed. Bits b4-b3 are ones that the numbers of these rows are represented as a binary number. Therefore, “00000” means that the right switch of the number “3” button is pushed and “10011” means that the left switch of the number “8” button is pushed.

In the data format, the b5 bit is a bit indicating whether the switch is pushed for a long time or whether the switch is pushed for a short time. If the value of the bit is 0, it indicates that the switch is pushed for a short time. On the other hand, if the value of the bit is 1, it indicates that the switch is pushed for a long time. The b6 bit is a bit indicating whether the two switches are pushed or not at the same time. If the value of the bit is 1, it indicates that the two switches are pushed at the same time. In case two switches of a button are pushed at the same time, they are pushed with a slight time difference. Also, though they are pushed at the same time, the beginning and end relationship are determined depending on the detection logic of the switching detector 760. The firstly-detected switch of the two switches is displayed from b4 to b0. “1000000” and “1000001” both indicate that the two switches of the number “3” button are pushed at the same time. More particularly, “1000000” indicates that the left switch is pushed after the right switch is pushed, and “1000001” indicates that the right switch is pushed after the left switch is pushed.

The b7 bit is used to determine whether the data just transmitted to the controller 761 is a correct data or not. If the bit b7 is set to 0, it indicates that the data just transmitted is an effective data along with transmittance of a new data. If the bit b7 is set to 1, it indicates that the remaining bits b6-b0 are all set to 1, thus becoming “11111111.” This indicates that the data just transmitted must be cancelled since it is an erroneous data.

Explaining this definition as an example of an actual error correction, “00010101” indicates that the left switch of the number “7” button is pushed for a short time, which corresponds to the letter “Q” in the English mode. The following “11111111” indicates that the data transmitted just before must be deleted since it is a transitional data. Therefore, the just transmitted “Q” will be deleted. The following “00110101” indicates that the left switch of the number “7” button is pushed for a long time, which corresponds to the letter “P” in the English mode. Therefore, the letter “Q” is replaced with the letter “P”.

As the touch whether the switch is pushed for a long time or the switch is pushed for a short time must be adequately transmitted to the user, the controller 761 outputs a “beep” sound via the buzzer 765 if the bit b5 in the data transmitted from the switching detector 760 is set to 1. The case that the button must be pushed for a long time corresponds to the cases that the letters “P” and “Z” are inputted and that the numbers and letter input modes must be set. In case that the left buttons of the number “1” button, “4” button and “*” button are pushed for a long time, a specific letter input mode, which will be explained later, is set. This indicates that how the data inputted later via the switch of the button is interpreted. Therefore, the user must understand whether a corresponding mode is selected or not. Thus, if a corresponding mode is set, lamps 762, 763 and 764 located at the pictogram on the left of respective buttons are lighted. These lamps use LEDs as a light source. Therefore, if the bit b5 in the data transmitted to the controller 761 is set to 1, the bits b4-b0 are interpreted. Then, if they belongs to the left switch of the number “1” button, the first lamp 62 is lighted. If they belongs to the left switch of the number “4” button, the second lamp 63 is lighted. If they belongs to the left switch of the “*” button, the third lamp 64 is lighted. The lamp once lighted will extinguish if other letter mode is selected. Also, if it is not a letter input mode, all the lamps extinguish. Instead of lighting the lamps, corresponding letter modes may be displayed on the display. In the display, a reference numeral 767 indicates that the number input mode is selected, and reference numerals 768 and 769 indicates that alphabet capital letters and alphabet small letters are selected, respectively.

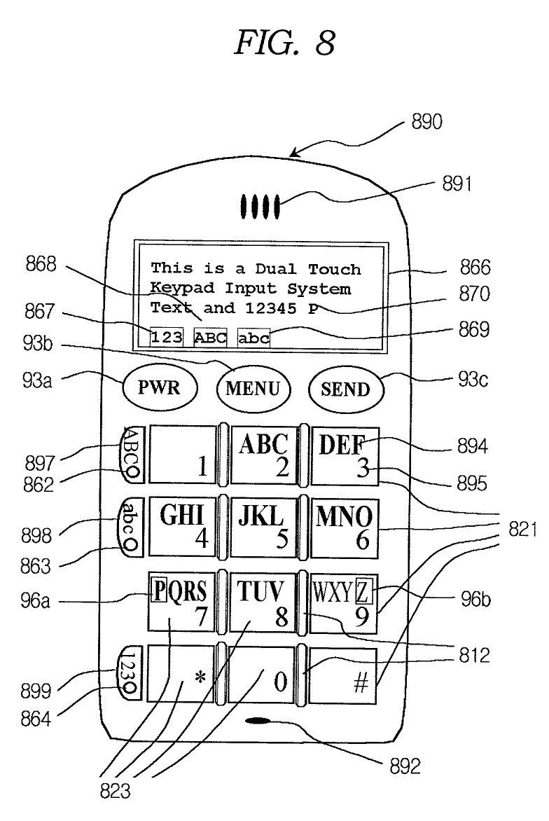

FIG. 8 is an exterior view of the telephone on which the keypad shown in FIG. 1 is mounted. The telephone generally includes a microphone 892, function switches 93a, 93b and 93c, a keypad button 821 and a display 866. The functions of the function switches 93a, 93b and 93c are same with those used in the common telephone. On the keycap on the keypad is printed letters such as ABC, DEF, PQRS, etc., which are same with those in the common telephone. In the present invention, the surroundings of the letters P 96a and Z 96b are boxed in order to discriminate from other letters. In addition to it, however, other methods by which they have different colors, they have unevenness, etc. may be employed in order to discriminate them from other letters. This visually informs to the user that the button must be pushed for a long time, in case that it is pushed for inputting a corresponding letter. Except for the two letters, the remaining 24 letters of the 26 letters in the English alphabet are longitudinally arranged in parallel on the eight keycaps for every 3 letters. They intuitively informs to the user that the letter arranged on the left is a left push, that the letter arranged on the right is a right push and that the letter arranged at the middle is a middle push.

The letters “ABC” 897 of a pictogram shape displayed on the left of the number “1” button represents that the English alphabet capital input mode is set if the left of the ABC button is pushed for a long time. Similarly, the letters “abc” 898 on the left of the number “4” button represents that a small letter input mode in the English alphabets is set, and the letters “123” 899 on the left of the “*” button represents that the number input mode is set.

As described in detail, the present invention has an outstanding advantage that it can input the capital and small letters in the English alphabets and the numbers only using twelve buttons, thus allowing a telephone to be used as a terminal of a letter communication.

More particularly, the present invention has the following effects: (1) it can significantly reduce the size of the system requiring input of letters and can thus increase the portability since it can efficiently input the letters only using twelve buttons less than ⅓compared to the number of the buttons in the common computer keyboard, (2) it can increase the input speed since it completes all the input of letters by a single stroke, (3) it allows users to intuitively manipulate the buttons since the locations of the letters arranged on the keycap of the button correspond to those of the buttons on which the users pushes, thus reducing possibility of error upon input, and (4) it can increase the size per one button to facilitate the manipulation since the relatively-less number of buttons are arranged within a limited area.

Further, by mounting the keypad of the present invention on a portable computer, a PDA, a two-way letter radio pager, a TV remote controller, etc., the present invention can reduce the size of these apparatus while improving the efficiency of letter input. Also by applying the present invention to an electronic diary, an electronic dictionary, etc., which adopt a keyboard-type letter arrangement scheme, a smooth letter input will be made possible with a minimum input button.

The present invention has been described with reference to a particular embodiment in connection with a particular application. Those having ordinary skill in the art and access to the teachings of the present invention will recognize additional modifications and applications within the scope thereof.

It is therefore intended by the appended claims to cover any and all such applications, modifications, and embodiments within the scope of the present invention.

What is claimed are:

1. A keypad apparatus in a telephone in which a plurality of push buttons are arranged in rows and columns in a grid shape, comprising:
each of said buttons are freely pushed right and left, two switches for connecting/disconnecting an electrical flow are installed at the right and left of said each of the push buttons,
wherein if the lefts of said push buttons are pushed left switches are connected, if the rights of said push buttons are pushed right switches are connected and if the middles of said push buttons are pushed both the right and left switches are connected.

2. The keypad apparatus in a telephone according to claim 1, further comprising a shied wall having a given height between the push buttons arranged in rows and columns in order to discriminate the plurality of push buttons arranged in rows and columns.

3. The keypad apparatus in a telephone according to claim 1, wherein the right and left edges of the plurality of push buttons are formed higher by a given height than the middle portion of the plurality of push buttons.

4. The keypad apparatus in a telephone according to claim 1, wherein the middle portion of the plurality of push buttons are formed lower by a given depth than the right and left edges of the plurality of push buttons.

5. The keypad apparatus in a telephone according to claim 1, wherein the switch is form ed using a membrane tactile method.

6. The keypad apparatus in a telephone according to claim 5, wherein two projections are formed at the right and left sides overlying the plurality of push buttons, so that the left projection corresponds to the left switch and the right projection corresponds to the right switch, and
wherein when the left buttons of the plurality of the push buttons are pushed, the right and left projections push the upper side of the right and left switches while the right and left sides of the plurality of the push buttons are get folded.

7. The keypad apparatus in a telephone according to claim 1, wherein the keypad apparatus is constructed to input all the alphabet letter, numbers and special keys, by matching two alphabet letters for every two switches in each of the plurality of push buttons and matching one of the alphabet letters when the two switches are pushed at the same time, depending on a predetermined method.

8. The keypad apparatus in a telephone according to claim 7, wherein said switches match the letters by discriminating the case it is pushed for a longer time than a given time and the case it is pushed for a shorter time than a given time, respectively.

9. The keypad apparatus in a telephone according to claim 8, wherein the buttons for matching the letters by discriminating the case it is pushed for a longer time than a given time and the case it is pushed for a shorter time than a given time, respectively has a box hoop or a circular hoop on their surfaces in order to discriminate other buttons.

10. A keypad apparatus in a telephone in which a plurality of push buttons are arranged in rows and columns in a grid shape, comprising:
a switch input means wherein two push switches are consisted of for every one of the plurality of push buttons;
a switch detecting means for detecting the connecting state in each of switch contacts to determine whether any of the switches is connected or not;
a controller means for converting the switch input state determined at the switch detecting means into a predetermined format data format; and
a display means for displaying the contents of the input data by means of the controller means,
wherein each of the push buttons are freely pushed right and left, two switches for connecting/disconnecting an electrical flow are installed at the right and left of each of the push buttons,
wherein if the lefts of said push buttons are pushed left switches are connected, if the rights of said push buttons are pushed right switches are connected and if the middles of said push buttons are pushed both the right and left switches are connected.

11. The keypad apparatus in a telephone according to claim 10, further comprising a buzzer for generating a given sound depending on a predetermined rule according to the contents of data transmitted from the switch detecting means.

12. The keypad apparatus in a telephone according to claim 10, further comprising a lamp for lighting or un-lighting depending on a predetermined rule according to the contents of data transmitted from the switch detecting means.

13. The keypad apparatus in a telephone according to claim 10, wherein said switch detecting means disregards detection of other switches except for its opposite switch existing at the same button if a switch firstly connected after all of the switches are open is detected, and also accepts only the case the contact of the switch connected firstly connected is open or the case the contact of the opposite switch at the same button, as a continuous input.

14. The keypad apparatus in a telephone according to claim 10, further comprising a shied wall having a given height between the push buttons arranged in rows and columns in order to discriminate the plurality of push buttons arranged in rows and columns.

15. The keypad apparatus in a telephone according to claim 10, wherein the right and left edges of the plurality of push buttons are formed higher by a given height than the middle portion of the plurality of push buttons.

16. The keypad apparatus in a telephone according to claim 10, wherein the middle portion of the plurality of push buttons are formed lower by a given depth than the right and left edges of the plurality of push buttons.

17. The keypad apparatus in a telephone according to claim 10, wherein the switch is formed using a membrane tactile method.

18. The keypad apparatus in a telephone according to claim 17, wherein two projections are formed at the right and left sides overlying the plurality of push buttons, so that the left projection corresponds to the left switch and the right projection corresponds to the right switch, and
wherein when the left buttons of the plurality of the push buttons are pushed, the right and left projections push the upper side of the right and left switches while the right and left sides of the plurality of the push buttons are get folded.

19. The keypad apparatus in a telephone according to claim 10, wherein the keypad apparatus is constructed to input all the alphabet letter, numbers and special keys, by matching two alphabet letters for every two switches in each of the plurality of push buttons and matching one of the alphabet letters when the two switches are pushed at the same time, depending on a predetermined method.

20. The keypad apparatus in a telephone according to claim 19, wherein said switches match the letters by discriminating the case it is pushed for a longer time than a given time and the case it is pushed for a shorter time than a given time, respectively.
